(19) United States
(12) Patent Application Publication
(10) Pub. No.: US 2010/0074559 A1
(43) Pub. Date: Mar. 25, 2010

(54) DEVICE FOR INTERPOLATING IMAGE

(75) Inventor: Hiroshi Satou, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/558,623

(22) Filed: Sep. 14, 2009

(30) Foreign Application Priority Data
Sep. 24, 2008 (JP) 2008-244014

(51) Int. Cl. G06K 9/32; G06K 9/54

(52) U.S. Cl. 382/300; 382/305

(57) ABSTRACT

An image interpolation device, which can perform image interpolation at low cost and with low power consumption. The image interpolation device includes a pixel data storage which temporarily and sequentially holds, in the form of a plurality of unit pixel data groups, data of adjacent pixels in the vertical direction of input image data. The image interpolation device also includes an image memory which can store at least three of the unit pixel data groups. Unit pixel data groups held in the pixel data storage are sequentially written to the image memory. At least two unit pixel data groups stored in the image memory are read simultaneously.

### BACKGROUND OF THE INVENTION

1. Field of the Invention

This invention relates to an image interpolating device, which performs rotation, enlargement/reduction, resolution conversion, and other correction and adjustment of moving images or still images.

2. Description of the Related Art

Image interpolation methods are widely known. When rotating, enlarging, or resolution-changing of an input image is carried out to obtain a desired output image, an image interpolation method is applied to data for a plurality of adjacent pixels in the input image to generate the modified output pixel data. Widely known interpolation methods include nearest neighbor methods (closest-neighbor interpolation methods), bilinear methods in which calculations are carried out based on data for four adjacent pixels (bilinear interpolation methods), and bicubic methods in which calculations are carried out based on data for 16 adjacent pixels (cubic convolution interpolation methods).

Japanese Patent Application Kokai (Laid-open) No. 10-262206 discloses a resolution conversion device that uses a bilinear method. Memory is divided into four memory banks. Then, the data for four adjacent pixels in the input image is stored in the four memory banks respectively so that the data for these four adjacent pixels can be read (retrieved) simultaneously. The device disclosed in Japanese Patent Application Laid-open No. 10-262206 performs resolution conversion, but normally an interpolation method employing a similar bilinear method is employed in the case of image rotation or enlargement/reduction as well. Japanese Patent Application Laid-open No. 2002-247316 discloses an image duplication device which divides input image data, writes the data to a plurality of memory blocks, and reads the data.

The resolution conversion device of Japanese Patent Application Laid-open No. 10-262206 has a problem when writing an input image to memory and reading the image from memory to generate an output image are both performed with timing synchronized to a pixel clock. This problem is described below.

When using single-port memory, memory writing and memory reading cannot be performed simultaneously. Thus, writing and reading are performed sequentially. In this case, writing and/or reading is delayed, and appropriate image output becomes impossible.

If, in order to increase the speed of writing and reading, the clock frequency for writing and reading is for example made twice the frequency of the pixel clock, power consumption is increased.

When using dual-port memory that enables simultaneous writing and reading, the size of transistor gates is increased approximately twice, as compared with single-port memory. In light of the fact that memory used for image storage is already of substantial size, the use of the dual-port memory entails the increased cost of the chip.

### SUMMARY OF THE INVENTION

One object of the present invention is to provide an image interpolation device which is low in cost, and can perform image interpolation with low power consumption

According to a first aspect of the present invention, there is provided an image interpolation device that includes an image memory which stores input image data, and a memory write controller which controls writing of the input image data to the image memory. The image interpolation device also includes a memory read controller which controls reading of the input image data from the image memory. The image interpolation device also includes an interpolation unit which performs image interpolation on input image data read from the image memory and obtains interpolated image data. The image interpolation device further includes a pixel data holding unit (pixel data storage) which temporarily and sequentially holds, as a unit pixel data group, data for mutually adjacent pixels in the vertical direction of the input image data. The image memory can store at least three of the unit pixel data groups. The memory write controller sequentially writes a unit pixel data group from the pixel data storage to the image memory. The memory read controller simultaneously reads at least two groups among the unit pixel data groups stored in the image memory.

The image interpolation device of this invention has a plurality of single-port memory units, and carries out image data writing and reading in parallel. Thus, image rotation and other image correction can be performed at low cost and with low power consumption.

The pixel data storage may temporarily and sequentially hold, as the unit pixel data group, one pixel data in an odd-numbered line of the input image data and one pixel data in an even-numbered line adjacent to the odd-numbered line pixel data. The image memory may include at least three single-port memory units for odd-numbered lines, which store pixel data for odd-numbered lines of the input image data, and at least three single-port memory units for even-numbered lines, which store pixel data for even-numbered lines of the input image data. The memory write controller may sequentially write pixel data for the odd-numbered lines of the unit pixel data groups held in the pixel data storage to the single-port memory units for odd-numbered lines, and may sequentially write pixel data for the even-numbered lines of the unit pixel data groups to the single-port memory units for even-numbered lines. The memory read controller may simultaneously read pixel data stored in each of at least two continuous memory units among the single-port memory units for odd-numbered lines, and pixel data stored in each of at least two continuous memory units among the single-port memory units for even-numbered lines. The number of the single-port memory units for odd-numbered lines may be 2×n, where n is an integer equal to or greater than 2. The number of the single-port memory units for even-numbered lines may be 2×m, where m is an integer equal to or greater than 2.

According to another aspect of the present invention, there is provided another image interpolation device that includes an image memory which stores input image data and a memory write controller which controls writing of the input image data to the image memory. This image interpolation device also includes a memory read controller which controls reading of the input image data from the image memory. The image interpolation device also includes an interpolation unit which performs image interpolation on input image data read from the image memory and obtains interpolated image data. The image interpolation device also includes a pixel data storage which temporarily and sequentially holds continuous pixel data along odd-numbered lines among horizontal lines of the input image data and pixel data of even-numbered lines adjacent to the odd-numbered line pixel data. The pixel data storage temporarily and sequentially holds, as a unit pixel data group, one pixel data in an odd-numbered line of the input image data and one pixel data in an even-numbered line adjacent to the odd-numbered line pixel data. The image memory includes at least three single-port memory units for odd-numbered lines, which store pixel data for odd-numbered lines of the input image data, and at least three single-port memory units for even-numbered lines, which store pixel data for even-numbered lines of the input image data. The memory write controller sequentially writes pixel data for the odd-numbered lines of the unit pixel data groups held in the pixel data storage to the single-port memory units for odd-numbered lines, and sequentially writes pixel data for the even-numbered lines of the unit pixel data groups to the single-port memory units for even-numbered lines. The memory read controller simultaneously reads pixel data stored in each of at least two continuous memory units among the single-port memory units for odd-numbered lines, and pixel data stored in each of at least two continuous memory units among the single-port memory units for even-numbered lines.

These and other objects, aspects and advantages of the present invention will become apparent to those skilled in the art from the following detailed description when the detailed description is read and understood in conjunction with the appended claims and drawings.

### BRIEF DESCRIPTION OF THE DRAWINGS

FIG. 1 is a block diagram showing an image interpolation device according to one embodiment of the present invention;

FIG. 2 shows the arrangement of pixel data of an input image;

FIG. 3 shows the relationship between memory units #0 to #15 and the numbers of pixel data shown in FIG. 2;

FIG. 4A illustrates an input image before performing angle correction;

FIG. 4B illustrates an output image after the angle correction;

FIG. 5 shows the input image coordinates corresponding to the output image coordinates together with four adjacent pixel data;

FIG. 6 is a block diagram showing details of a memory write controller;

FIG. 7 is a block diagram showing details of a memory read controller;

FIG. 8 schematically shows processing in the image interpolation device shown in FIG. 1;

FIG. 9 is a flowchart showing a writing routine;

FIG. 10 is a flowchart showing an interpolated pixel data generating routine;

FIG. 11 is a time chart showing write memory selection signals and read memory selection signals indicating memory numbers, together with the pixel clock;

FIG. 12A to FIG. 12E schematically show memory numbers for writing and reading in different occasions;

FIG. 13A to FIG. 13E also show memory numbers for writing and reading in different occasions;

FIG. 14 shows another arrangement of input image pixel data; and

FIG. 15 shows image memory having three odd-numbered line memory units and three even-numbered line memory units.

### DETAILED DESCRIPTION OF THE INVENTION

Below, embodiments of the invention are explained in detail, referring to the attached drawings.

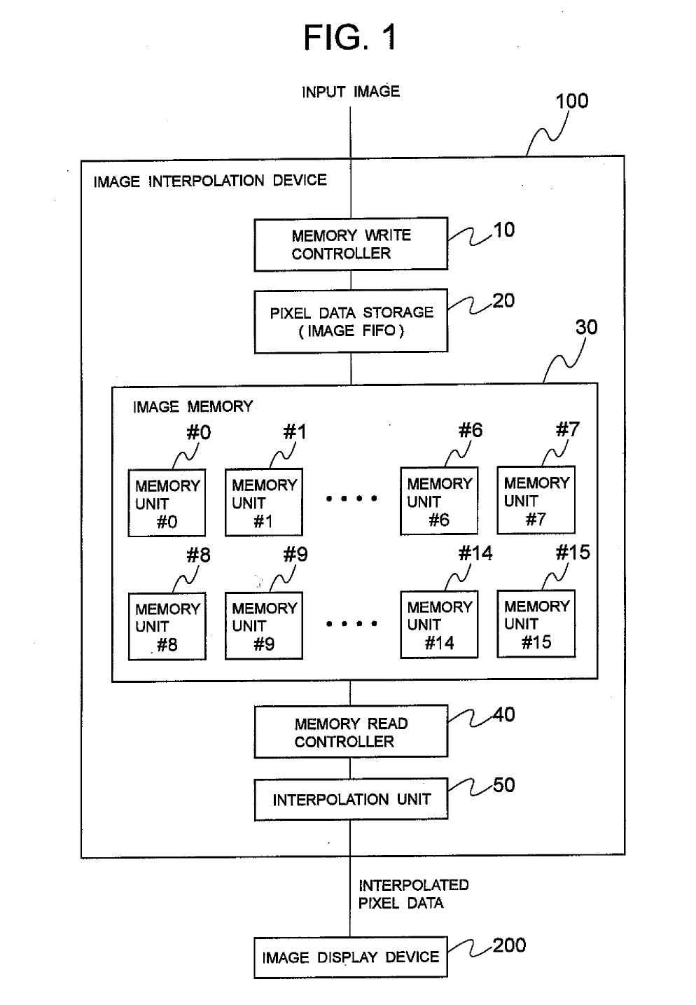

FIG. 1 is a block diagram of an image interpolation device 100 of this embodiment. The image interpolation device 100 includes a memory write controller 10, pixel data holding unit 20, image memory 30, memory read controller 40, and interpolation unit 50. The image interpolation device 100 performs rotation, enlargement/reduction, resolution conversion, and other correction and adjustment of moving images or still images. In particular, the image interpolation device 100 is suited for image correction with a bilinear method. Below, an example is explained of a case in which the image interpolation device 100 performs angle correction on an input image (i.e., rotates the input image) to obtain a rotated image as the output image. Below, an input image refers to one among a plurality of input moving images.

The memory write controller 10 controls writing to the pixel data holding circuit 20 for pixel data of an input image and to the image memory 30.

The pixel data holding circuit 20 (hereafter called an image FIFO (First In First Out) 20) temporarily and sequentially holds pixel data of the input image. Specifically, the image FIFO 20 temporarily and sequentially holds data for pixels which are adjacent in the vertical direction (hereafter called a unit pixel data group) in the input image. That is, a unit pixel data group is a group of two pixel data, namely, pixel data for one pixel in an odd-numbered line among the horizontal lines of the input image, and another pixel data for one pixel in an even-numbered line adjacent to the odd-numbered horizontal line pixel data. The image FIFO 20 is for example a flip-flop or any other suitable memory element.

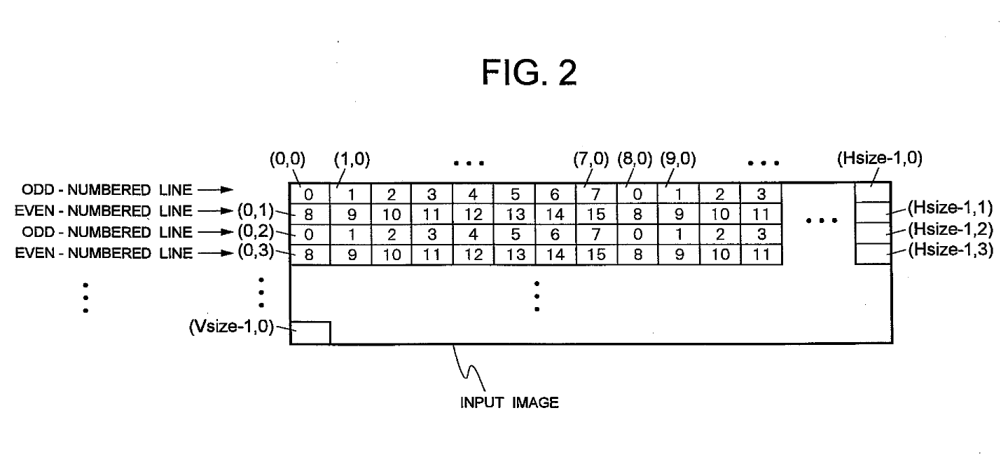

FIG. 2 shows the arrangement of pixel data of an input image. Pixel data may for example be in YUV 4:4:4 format or RGB format or monochrome (black-and-white) format. For convenience in relation to memory units #0 to #15 (will be described below), numbers are assigned to the data for each pixel of the input image. For example, the pixel data on coordinates (0,0), (1,0), . . . , (7,0) are assigned the numbers 0, 1, . . . , 7, respectively. Similarly, for coordinates (8,0), (9,0), . . . , the numbers 0, 1, . . . are assigned. In the horizontal line with coordinates from (0,0) to (Hsize−1, 0), numbers from 0 to 7 are assigned in repetition.

In the horizontal line from coordinates (0,1) to (Hsize−1,1), the numbers 8 to 15 are assigned in repetition. Below, the numbers from 0 to 7 are assigned in repetition for odd-numbered lines (the first line, third line, . . . ) among horizontal lines, and the numbers from 8 to 15 are assigned in repetition for even-numbered lines (the second line, fourth line, . . . ). In FIG. 2, Hsize is the number of effective pixels in a horizontal line in the input image, and may for example be 640. Vsize is the maximum number of pixels in a vertical line in the input image, and may for example be 525.

For example, the pixel data group comprising the pixel data 0 of an odd-numbered line and the pixel data 8 of an even-numbered line is a unit pixel data group. The pixel data 1 and 9, 2 and 10, . . . , and 7 and 15 are each likewise unit pixel data groups.

The image memory 30 sequentially stores unit pixel data groups from the pixel data storage 20. The image memory 30 is divided into 16 units, namely, memory units #0 to #15. Each of the memory units #0 to #15 is single-port memory, with a common port for writing and for reading.

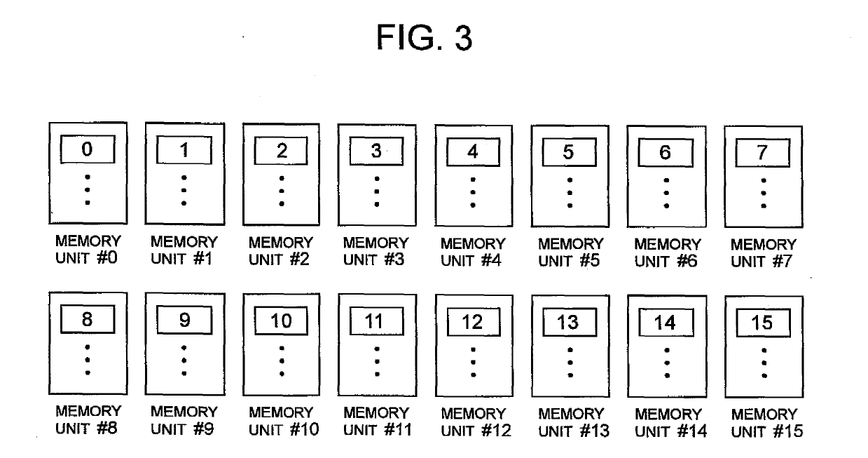

FIG. 3 shows the relationship between memory units #0 to #15 and the numbers of image data shown in FIG. 2. Memory unit #0 stores the pixel data with number 0 among the pixel data shown in FIG. 2. Memory unit #0 sequentially stores pixel data with number 0 in the first odd-numbered line, with coordinates (0,0), (8,0), . . . . Memory unit #0 similarly sequentially stores pixel data with number 0 in the third and subsequent odd-numbered lines.

Similarly, memory unit #1 stores pixel data with number 1, memory unit #2 stores pixel data with number 2, and so on, and memory unit #7 stores pixel data with number 7. As is clear from FIG. 2 and FIG. 3, memory units #0 to #7 store pixel data for odd-numbered lines among the horizontal lines of the input image. Below, memory units #0 to #7 are called odd-line single-port memory units. The image memory 30 starts storing pixel data from the first odd-line single-port memory unit #0 among the odd-line single-port memory units #0 to #7. Upon finishing the storing of pixel data up to the last odd-line single-port memory unit #7, the image memory 30 again stores data from the odd-line single-port memory unit #0.

Similarly, the memory unit #8 stores pixel data with number 8, the memory unit #9 stores pixel data with number 9, and so on, and memory unit #15 stores pixel data with number 15. As is understood from FIG. 2 and FIG. 3, memory units #8 to #15 store pixel data for even-numbered lines among the horizontal lines of the input image. Below, memory units #8 to #15 are called even-line single-port memory units. The image memory 30 starts storing pixel data from the first even-line single-port memory unit #8 among the even-line single-port memory units #8 to #15. Upon finishing the storing of pixel data up to the last even-line single-port memory unit #15, the image memory 30 again stores data from the even-line single-port memory unit #8. Each of the memory units #0 to #15 stores, for example, pixel data for 64 horizontal lines.

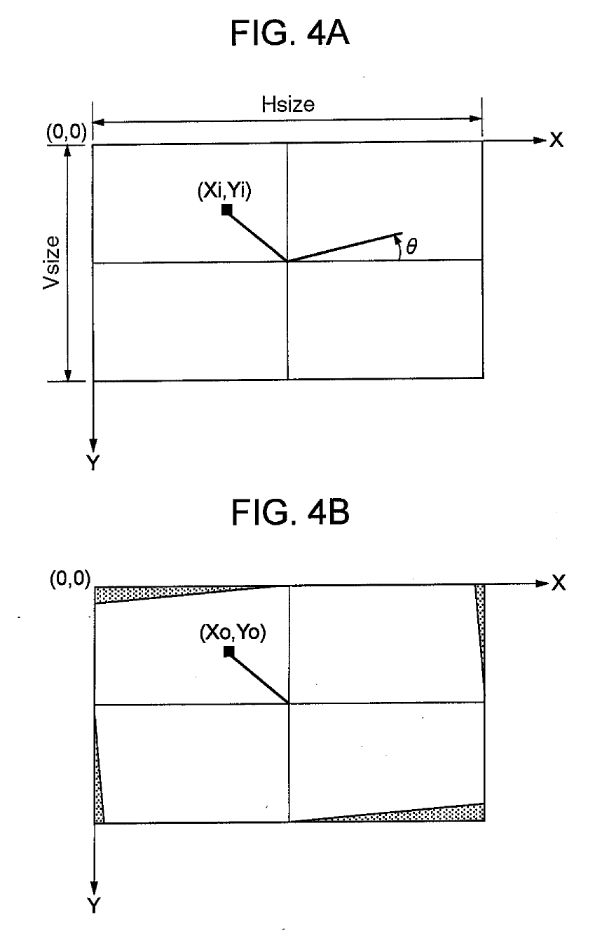

The memory read controller 40 reads pixel data from the image memory 30 and supplies the pixel data to the interpolation unit 50. At this time, the memory read controller 40 simultaneously reads pixel data for four adjacent pixels for use in interpolation. FIG. 4A and FIG. 4B show an input image and an output image when angle correction is carried out. Specifically, the input image of FIG. 4A is rotated through θ (predetermined angle) to obtain the output image of FIG. 4B.

The memory read controller 40 first uses Equation 1 to determine the input image coordinates (Xi,Yi) corresponding to the output image coordinates (Xo,Yo).

$$( \begin{matrix}Xi \\ Yi\end{matrix} ) - ( \begin{matrix}Hsize / 2 \\ Vsize / 2\end{matrix} ) = ( \begin{matrix}cos θ & - sin θ \\ sin θ & cos θ\end{matrix} ) \cdot ( \begin{matrix}( \begin{matrix}Xo \\ Yo\end{matrix} ) - \\ ( \begin{matrix}Hsize / 2 \\ Vsize / 2\end{matrix} )\end{matrix} ) \qquad Equation 1$$

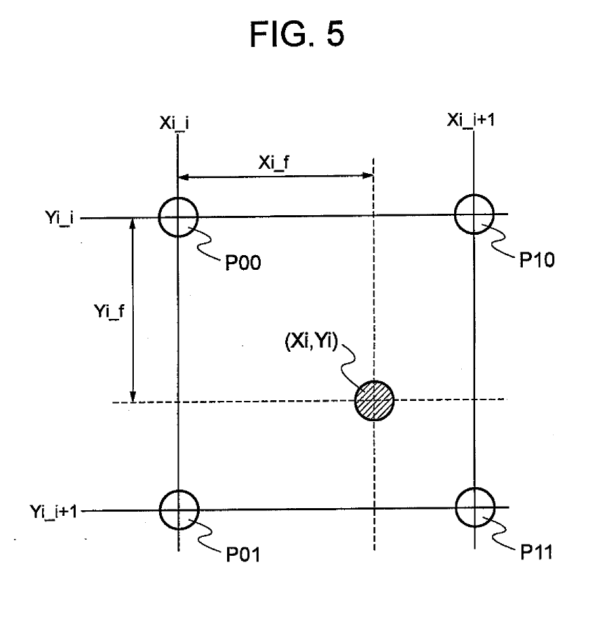

Next, the memory read controller 40 divides the Xi and Yi into an integer part and a fraction part. That is, the memory read controller 40 provides Xi=Xi_i (integer part)+Xi_f (reaction part), and Yi=Yi_i (integer part)+Yi_f (fraction part). FIG. 5 shows the position of the input image coordinates (Xi,Yi) corresponding to the output image coordinates (Xo,Yo) and the positions of four adjacent pixel data P00, P01, P10, and P11. The coordinate of the pixel data P00 is (Xi_i,Yi_i), the coordinate of the pixel data P01 is (Xi_i,Yi_i+1), the coordinate of the pixel data P10 is (Xi_i+1,Yi_i), and the coordinate of the pixel data P11 is (Xi_i+1,Yi_i+1). The memory read controller 40 reads the four pixel data P00, P01, P10 and P11 from the image memory 30, and supplies the pixel data to the interpolation unit 50.

The interpolation unit 50 generates one interpolated pixel data value Q based on the four pixel data values P00, P01, P10, P11 from the memory read controller 40. More specifically, the interpolation unit 50 uses Equation 2 to compute the interpolated pixel data value Q.

Q=(1−Xi_{—}f)·(1−Yi_{—}f)·P00+Xi_{—}f·(1−Yi_{—}f)·P10+(1−Xi_{—}f)·Yi_{—}f·P01+Xi_{—}f·Yi_{—}f·P11 Equation 2

The interpolated pixel value Q represents, in the form of a numerical value, color information of the output image at the coordinates (Xo,Yo).

An image display device 200 generates the output image based on the interpolated pixel data values Q from the interpolation unit 50 and vertical and horizontal synchronization signals from the memory read controller 40. The output image is the image resulting from rotation of the input image through the angle θ.

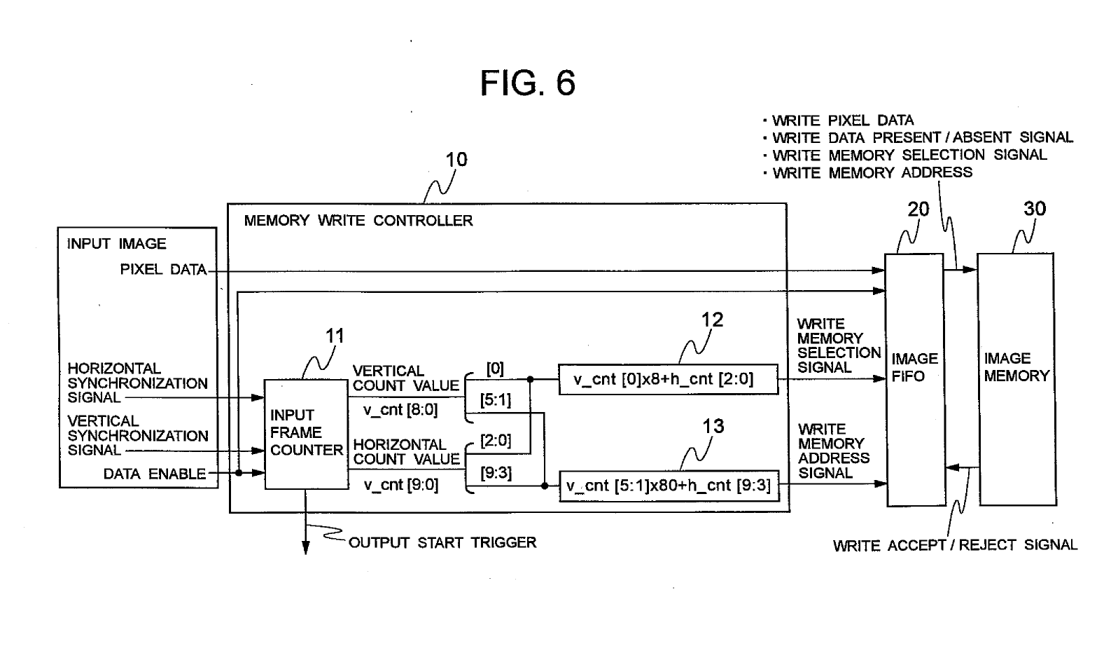

FIG. 6 is a block diagram showing details of the memory write controller 10. The memory write controller 10 includes an input frame counter 11, write memory selecting circuit 12, and write memory address specifying circuit 13.

The input frame counter 11 is controlled by a data enable signal, and counts the pixel data coordinates of the input image to be stored in the pixel data storage 20 based on the horizontal synchronization signal and vertical synchronization signal. Specifically, the input frame counter 11 counts both a vertical count value and a horizontal count value, and supplies these count values to the write memory selection circuit 12 and to the write memory address specification circuit 13. The vertical count value represents a vertical-direction coordinate of the input image, and the horizontal count value represents a horizontal-direction coordinate of the input image. The vertical count value is represented by the nine bits of v_cnt[8:0], and the horizontal count value is represented by the ten bits of h_cnt[9:0].

More specifically, the input frame counter 11 supplies the vertical count value v_cnt[0] to the write memory selection circuit 12 and the vertical count value v_cnt[5:1] to the write memory address specification circuit 13. The input frame counter 11 supplies the horizontal count value h_cnt[2:0] to the write memory selection circuit 12 and the vertical count value v_cnt[9:3] to the write memory address specification circuit 13. When for example counting of 32 horizontal lines of the input image is completed (that is, when 32 lines of pixel data have been stored in the image memory 30), the input frame counter 11 sends an output start trigger, commanding the start of pixel data reading, to an output frame counter (will be described below).

The write memory selection circuit 12 selects the memory unit for storing pixel data from among the memory units #0 to #15, based on the vertical count value and horizontal count value from the input frame counter 11. Specifically, the write memory selection circuit 12 uses the value calculated by the formula v_cnt[0]×8 h_cnt[2:0] as the number of the memory unit to be selected. In this formula, v_cnt[0]×8 corresponds to associating memory units #0 to #15 with two lines, one odd and one even, in the vertical direction, and associating one horizontal line with eight memory units, as shown in FIG. 3. In the formula, h_cnt[2:0] corresponds to associating eight memory units with one horizontal line. The write memory selection circuit 12 supplies a write memory selection signal indicating the number of the memory unit to be selected, to the pixel data holding circuit 20.

The write memory address specification circuit 13 specifies the memory address at which pixel data is to be stored, based on the vertical count value and horizontal count value from the input frame counter 11. Specifically, the write memory address specification circuit 13 uses the value calculated by the formula v_cnt[5:1]×80+h_cnt[9:3] as the memory address to be specified. In this formula, h_cnt[9:3] (0 to 79) and 80 reflects a fact that when there are 640 pixels in one horizontal line of an input image, 640 pixels/8 memory units=80 because the number of memory units for one horizontal line is eight. In the formula, v_cnt[5:1] (0 to 31) reflects a fact that when each of the memory units #0 to #15 can store pixel data for 64 horizontal lines, 64 lines/2 lines=32 because the memory units #0 to #15 are associated with two lines, one odd and one even, in the vertical direction. The write memory address specification circuit 13 supplies a write memory address signal indicating the memory address at which pixel data is to be stored, to the pixel data storage 20.

The pixel data storage 20 temporarily stores pixel data of the input image. The pixel data storage 20 sends a write memory selection signal, a write memory address signal, and a write data present/absent signal to the image memory 30. The write data present/absent signal indicates whether pixel data is currently stored in the pixel data storage 20. The pixel data storage 20 supplies pixel data to the image memory 30, according to a write accept/reject signal from the image memory 30. The write accept/reject signal indicates whether there is content between writing of pixel data to the image memory 30 and reading of pixel data from the image memory 30.

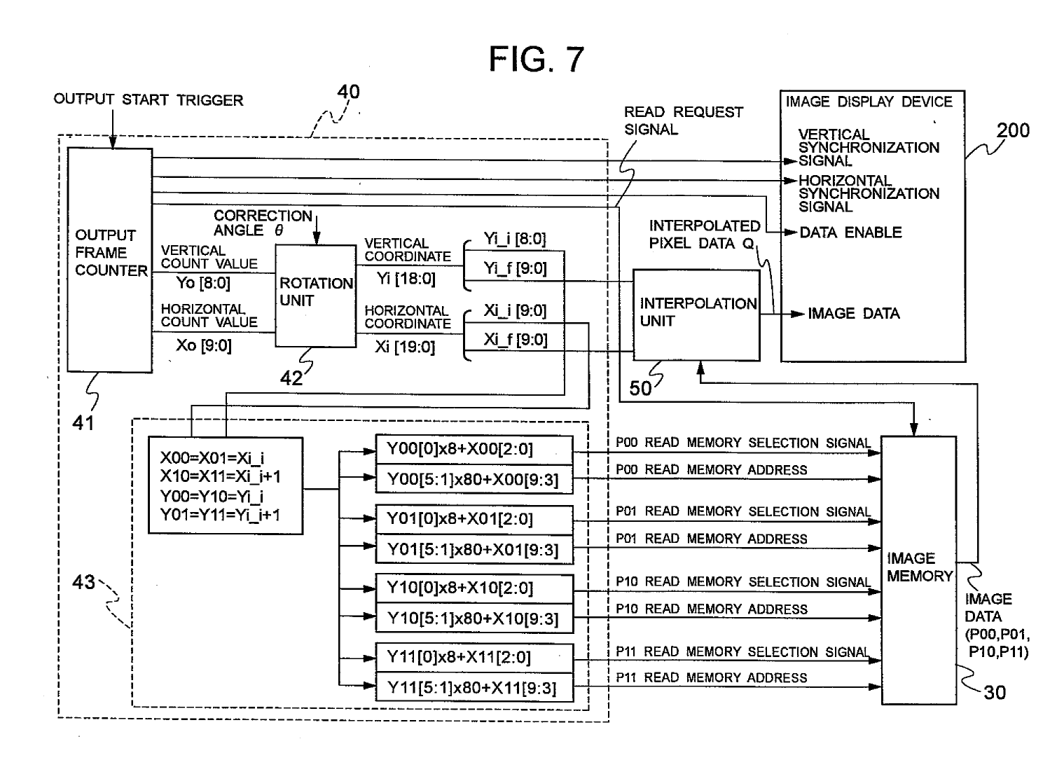

FIG. 7 is a block diagram showing details of the memory read controller 40. The memory read controller 40 has an output frame counter 41, rotation unit 42, and read memory selection circuit 43.

The output frame counter 41 counts pixel data coordinates of the output image according to the output start trigger from the input frame counter 11. Specifically, the output frame counter 41 counts both the vertical count value and the horizontal count value, and supplies these values to the rotation unit 42. The vertical count value indicates the vertical-direction coordinate of the output image, and the horizontal count value indicates the horizontal-direction coordinate of the output image. The vertical count value is represented by the nine bits of Yo[8:0], and the horizontal count value is represented by the ten bits of Xo[9:0].

The rotation unit 42 calculates the coordinates (Xi,Yi) of the input image obtained when the coordinates (Xo,Yo) of pixel data of the output image are rotated through a preset correction angle θ. Specifically, the rotation unit 42 calculates and outputs the vertical coordinate Yi[18:0] and horizontal coordinate Xi[19:0]. The vertical coordinate Yi has Yi_i[8:0], representing the integer part, and Yi_f[9:0], representing the fraction part. The horizontal coordinate Xi has Xi_i[9:0], representing the integer part, and Xi_f[9:0], representing the fraction part. The rotation unit 42 sends the coordinate integer parts Yi_i[8:0] and Xi_i[9:0] to the read memory selection circuit 43, and sends the coordinate fraction parts Yi_f[9:0] and Xi_f[9:0] to the interpolation unit 50.

The read memory selection circuit 43 selects the memory and specifies the memory address for reading of each of the four pixels P00, P01, P10, P11 adjacent to the coordinates (Xi,Yi) of the input image, based on the coordinate integer portion Yi_i[8:0] and Xi_i[9:0]. That is, the memory units in which are stored the four adjacent pixels (one among memory units #0 to #15) are selected, and the addresses are specified. For example, in the case of one pixel, P00, among the four adjacent pixels, X00=Xi_i and Y00=Yi_i are decided as shown in FIG. 7, and the memory unit number is calculated from the formula Y00[0]×8+X00[2:0], while the memory address is calculated from the formula Y00[5:1]×80+X00[9:3]. The reasons why these formulae are used are similar to the reasons for the formulae used by the write memory selection circuit 12 and the write memory address specification circuit 13.

The read memory selector 43 performs memory selection and memory address specification for each of the four adjacent pixels P00, P01, P10, P11. That is, the read memory selector 43 supplies a read memory selection signal representing a memory unit number and a read memory address signal representing an address in this memory unit to the image memory 30 for each of the four adjacent pixels P00, P01, P10, P11.

The image memory 30 retrieves the pixel data stored at the memory address represented by the read memory address signal in the memory unit with the memory number represented by the read memory selection signal (one among memory units #0 to #15) from the read memory selector 43 for each of the four adjacent pixels P00, P01, P10, P11, and supplies the pixel data to the interpolation circuit 50.

The interpolation circuit 50 uses the coordinate fraction parts Yi_f and Xi_f from the rotation unit 42 to calculate the interpolated pixel data Q using Equation 2. The interpolation unit 50 supplies the interpolated pixel data Q to the image display device 200.

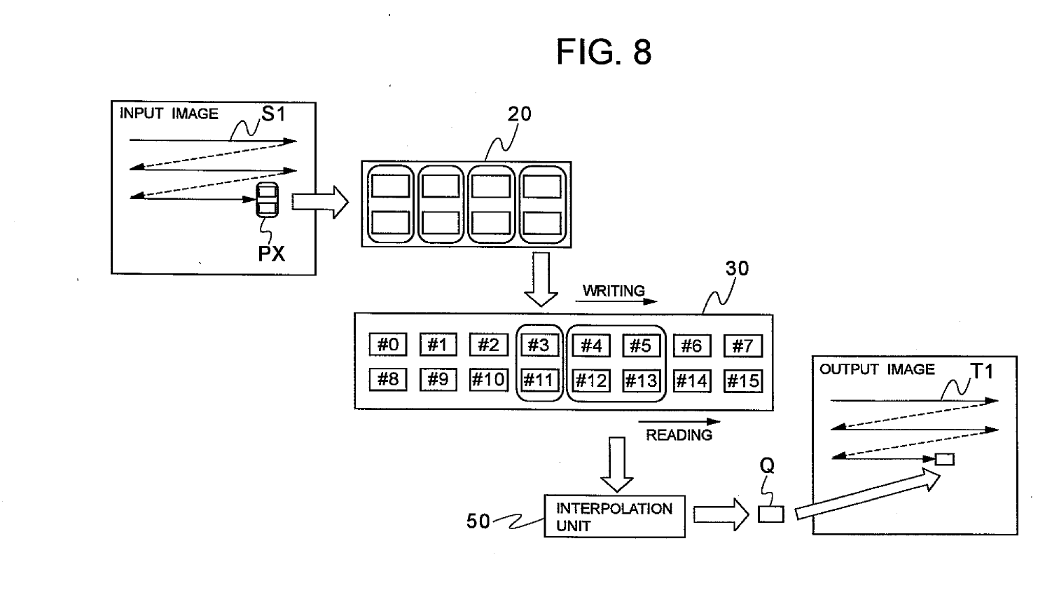

FIG. 8 schematically shows processing in the image interpolation device 100. It should be noted that the memory write controller 10 and memory read controller 40 are not shown in this drawing.

The input image introduced to the image interpolation device 100 is temporarily stored in the pixel data storage 20. Pixel data PX of the input image is supplied to the pixel data storage 20 in sequence according to the horizontal line method, as indicated by the arrows S1. At this time, the pixel data storage 20 simultaneously stores pixel data for two pixels. The pixel data storage 20 can for example temporarily store the pixel data for 8 pixels (2 pixels×4=8 pixels). Pixel data is stored in the pixel data storage 20 in synchronization with the timing of ½ the pixel clock frequency (once every two periods of the pixel clock). That is, the speed of storage of pixel data in the pixel data storage 20 is slower than the speed of writing to the pixel memory 30. Here, the pixel clock is normally a clock which corresponds to processing of data for one pixel. In this specification, the pixel clock is used with this generally accepted meaning.

Pixel data for two pixels (for example, pixel data to be stored in the memory unit #3 and memory unit #11) is stored sequentially in the image memory 30 from the pixel data storage 20. Pixel data is stored in the order of memory units #0 and #8, memory units #1 and #9, . . . , memory units #7 and #15. After one cycle, the pixel data is again stored from memory units #0 and #8. The pixel data is stored in the image memory 30 in synchronization with the pixel clock.

When there is contention between memory for storing (writing) and memory for reading, the image memory 30 gives priority to the reading and does not perform the writing. In this situation, the pixel data writing of which has been postponed is held in the pixel data storage 20, and when contention has ended, that pixel data is written to the image memory 30. For example, when memory units to be read are the memory units #2, #3, #10 and #11, and there is pixel data to be written to memory unit #2, then the data is held in the pixel data storage 20. When for example the memory units to be read become the memory units #3, #4, #11 and #12, writing to memory unit #2 is performed.

Pixel data for four pixels stored in the image memory 30 is read simultaneously, and is supplied to the interpolation unit 50. The pixel data for four pixels is for the four pixels adjacent to the pixel data coordinates (Xi,Yi) of the input image corresponding to the pixel data coordinates (Xo,Yo) of the output image, that is, P00, P01, P10, P11 shown in FIG. 5. The four adjacent pixels are stored separately in, for example, memory units #4, #5, #12, #13, so that even when the memory units #0 to #15 are each single-port memory units, simultaneous reading can be performed. Pixel data is read from the image memory 30 in synchronization with the pixel clock.

The interpolation unit 50 generates and outputs interpolated pixel data Q based on the four adjacent pixels sent from the image memory 30. The image display device 200 displays the output image along the direction of the arrows T1, based on the interpolated pixel data Q from the interpolation unit 50 and the horizontal and vertical synchronization signals (not shown) from the memory read controller 40.

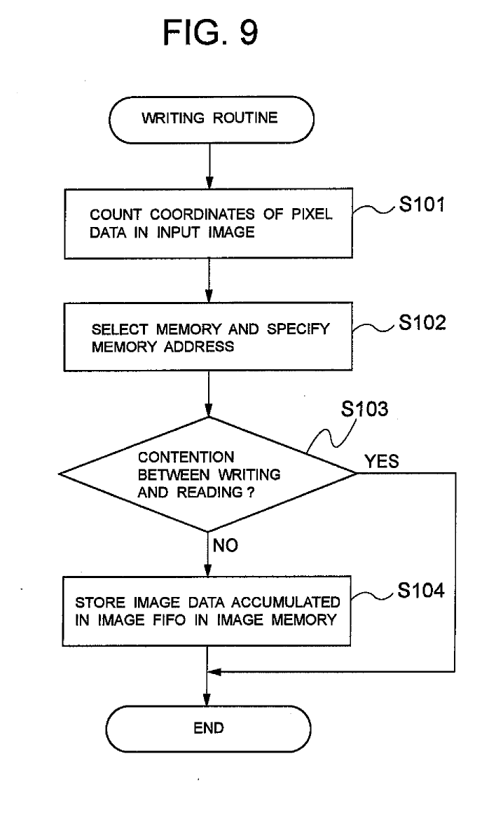

FIG. 9 is a flowchart showing a writing routine performed by the memory write controller 10. This writing routine is executed in synchronization with the pixel clock.

First, the input frame counter 11 counts image data coordinates in the input frame and obtains a vertical count value and a horizontal count value (step S101). The write memory selector 12 selects the memory unit to which pixel data should be written (one among memory units #0 to #15) based on the vertical count value and horizontal count value (step S102). The write memory address specification circuit 13 specifies the memory address at which pixel data should be written, based on the vertical count value and the horizontal count value (step 5102).

When the selected memory unit is memory for reading, the image memory 30 sends a write accept/reject signal indicating contention between writing and reading to the pixel data storage 20. On the other hand, when the selected memory unit is not memory for reading, the image memory 30 sends a write accept/reject signal indicating that writing is possible to the pixel data storage 20. The pixel data storage 20 determines whether writing and reading contention is occurring according to the write accept/reject signal (step S103).

Upon determining that there is contention based on the write accept/reject signal from the image memory 30, the pixel data storage 20 ends writing without supplying pixel data to the image memory 30. When on the other hand it is determined that there is no contention, the pixel data storage 20 supplies pixel data to the image memory 30, and the image memory 30 stores the supplied pixel data (step S104).

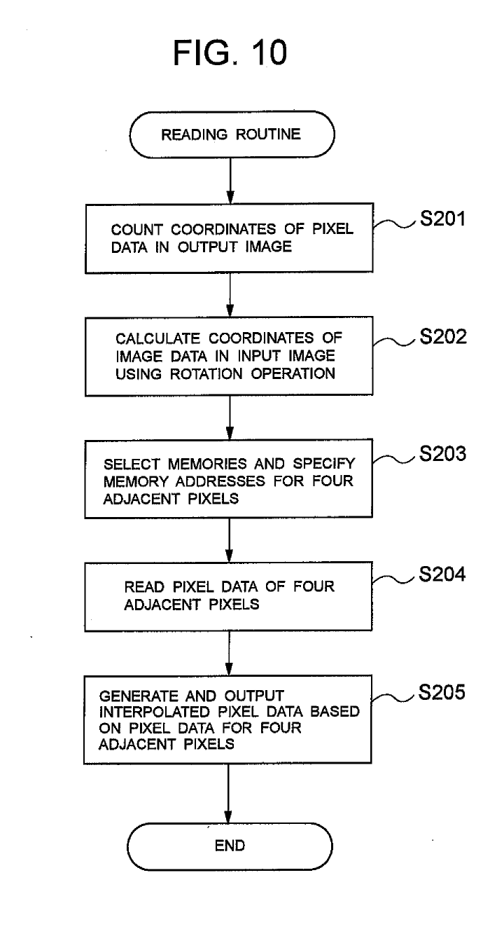

FIG. 10 is a flowchart showing an interpolated pixel data generation routine. This reading routine is executed in synchronization with the pixel clock. Interpolated pixel data generation is executed by the image memory 30, memory read controller 40, and interpolation operation circuit 50.

First, the output frame counter 41 counts image data coordinates (Xo,Yo) in the output frame and obtains a vertical count value and a horizontal count value (step S201). The rotation unit 42 performs rotation based on the vertical count value, the horizontal count value, and a preset correction angle θ, and calculates the image data coordinates (Xi,Yi) in the input image (step S202).

The read memory selector 43 selects the memory unit for pixel data reading (one among memory units #0 to #15) for each of the four adjacent pixels, based on the integer-part coordinates Xi_i and Yi_i of the coordinates (Xi,Yi) (step S203). The read memory selector 43 also specifies the memory address for pixel data reading for each of the four adjacent pixels, based on the coordinates Xi_i and Yi_i (step S203).

The image memory 30 simultaneously reads pixel data for four adjacent pixels from the memory addresses specified in the selected memories (step S204), and sends the pixel data to the interpolation circuit 50. The interpolation circuit 50 generates interpolated pixel data Q based on the pixel data of the four adjacent pixels (step S205). The above-described writing and interpolated pixel data generation are executed in parallel.

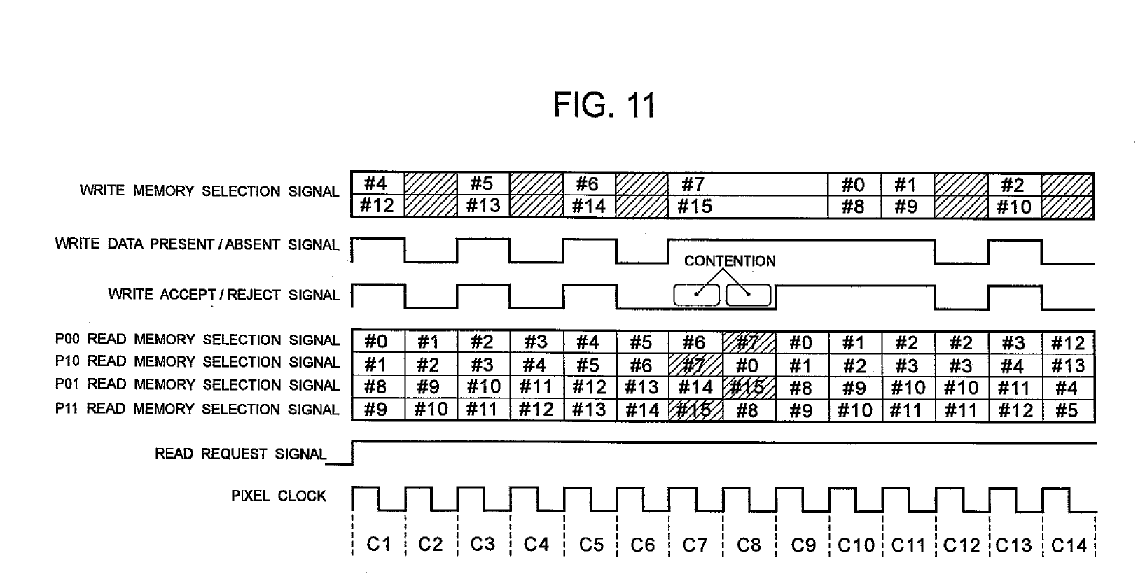

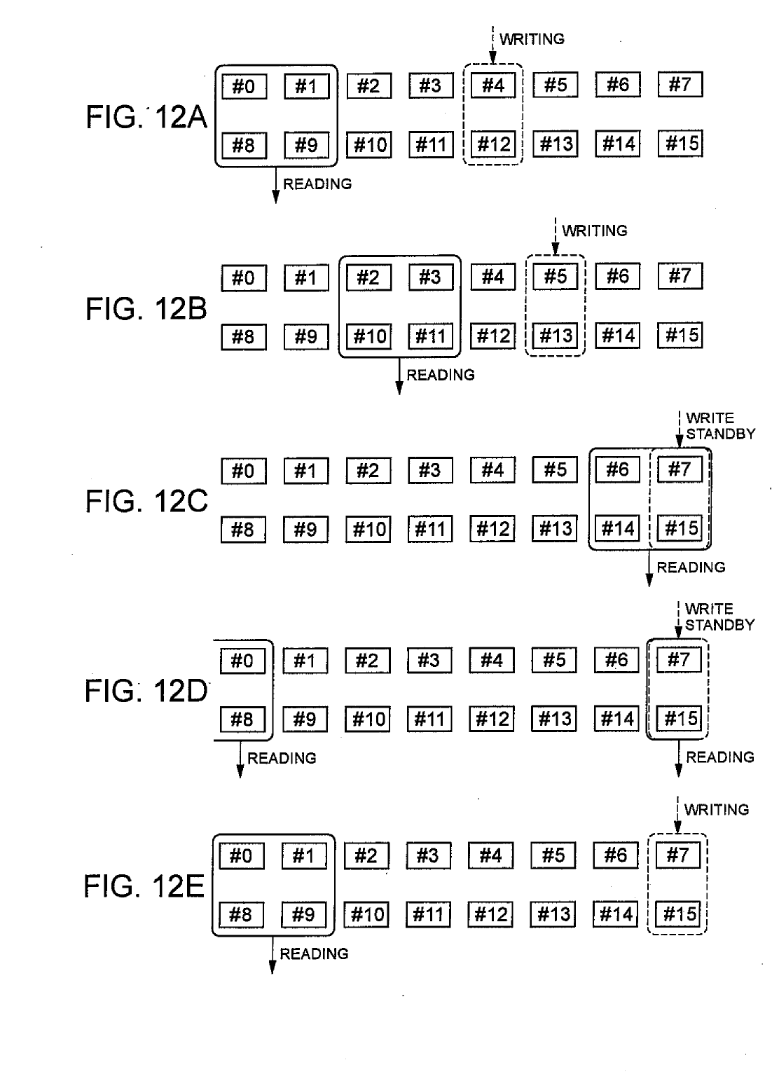

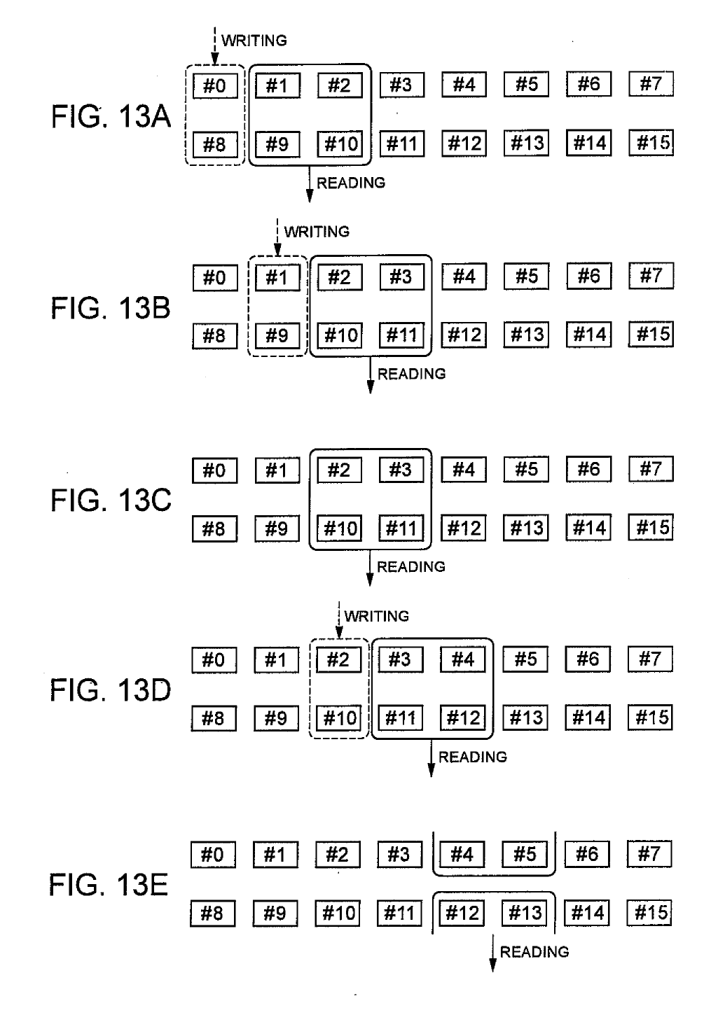

FIG. 11 is a time chart showing write memory selection signals and read memory selection signals indicating memory numbers, together with the pixel clock. FIGS. 12A to 12E and FIGS. 13A to 13E schematically show memory numbers for writing and/or reading. Below, operation of the image interpolation device 100 is explained, referring to FIG. 11, FIGS. 12A to 12E, and FIGS. 13A to 13E.

The write memory selection signal indicates one memory unit, among memory units #0 to #15, to which pixel data currently stored in the pixel data storage 20 is to be stored. The write memory selection signal is supplied from the write memory selection circuit 12 to the pixel data storage 20 and to the image memory 30. Two pixels are written simultaneously, and therefore the memory unit numbers supplied at one time may be, for example, #4 and #12.

The write data present/absent signal indicates whether pixel data is present or absent in the pixel data storage 20, and is supplied from the pixel data storage 20 to the image memory 30. When pixel data is present in the pixel data storage 20, the write data present/absent signal is at high level, and when there is no data, this signal is at low level.

The write accept/reject signal indicates whether or not the image memory 30 accepts writing, and is supplied from the image memory 30 to the pixel data storage 20. When the write data present/absent signal is at low level, or when there is contention between reading and writing, the write accept/reject signal is at low level, and writing is not accepted. When the write data present/absent signal is at high level and there is no contention between writing and reading, the write accept/reject signal is at high level, and writing is accepted.

The read memory selection signal indicates from which among the memory units #0 to #15 pixel data stored in the image memory 30 should be read. The read memory selection signal is supplied by the memory read controller 40 to the image memory 30. Four pixels are read simultaneously, so that the memory unit numbers supplied at one time may be, for example, #0, #1, #8, #9. The read memory selection signal is supplied for each of the four adjacent pixels P00, P01, P10, P11.

A read request signal is a signal from the output frame counter 41 requesting image reading by the image memory 30 in response to an output start trigger from the input frame counter 11. The read request signal is high when reading is requested. Each of the above-described signals is issued in synchronization with the pixel clock. Here, for convenience the symbols C1 to C14 are assigned to single periods of the pixel clock, as shown in FIG. 11, which are referred to as clock periods C1 to C14.

At the clock period C1, the write data present/absent signal is at high level, and pixel data to be written to the image memory 30 exists in the pixel data storage 20. At this time, the write memory selection signals are #4 and #12, indicating that pixel data should be written to memory units #4 and #12. On the other hand, the read memory selection signals are #0, #1, #8 and #9, so that there is no contention between memory units to which pixel data is to be written and memory units which should be read. The write accept/reject signal goes to high level, and the image memory 30 accepts writing and stores the pixel data in memory units #4 and #12. In the meanwhile, pixel data is read simultaneously from memory units #0, #1, #8 and #9. In FIG. 12A, the memory units surrounded by the solid line are memory units for reading, and the memory units surrounded by the dotted line are memory units for writing. In this way, writing and reading can be executed simultaneously in the clock period C1.

In the clock period C2, the write memory selection signal does not specify a memory number. This is because pixel data is stored in the pixel data storage 20 once in two pixel clock periods. At this time, pixel data is not written to the image memory 30. On the other hand, pixel data is read simultaneously from memory units #1, #2, #9 and #10.

The write memory selection signal indicates that pixel data is to be written, along horizontal lines of the input image, to memory units #5 and #13 in the clock period C3, to memory units #6 and #14 in the clock period C5, and to memory units #7 and #15 in the clock period C7. On the other hand, based on the calculation results of the read memory selector 43, the read memory selection signal indicates that image data is to be read from memory units #2, #3, #10 and #11 in the clock period C3, from memory units #3, #4, #11 and #12 in the clock period C4, . . . , and from memory units #6, #7, #14 and #15 in the clock period C7. The memory units for writing and memory units for reading in the clock period C3 are shown in FIG. 12B, and the memory units for writing and memory units for reading in the clock period C7 are shown in FIG. 12C. Writing and reading can be executed simultaneously from the clock period C1 to the clock period C6.

During the clock period C7, the write memory units are the memory units #7 and #15, and the read memory units are the memory units #6, #7, #14 and #15, so that there is contention for memory units #7 and #15. At this time, the write accept/reject signal goes to low level, and the image memory 30 does not accept writing. In the clock period C7, pixel data which should have been written to memory units #7 and #15 is temporarily held in the pixel data storage 20. Pixel data is read from the memory units #6, #7, #14, #15 during the clock period C7.

During the clock period C8, pixel data to be written to memory units #7 and #15 is held in the pixel data storage 20, and therefore the write memory selection signal indicates #7 and #15. On the other hand, the read memory units are memory units #7, #0, #15 and #8, so that in the clock period C8, there is contention for memory units #7 and #15. At this time, the write accept/reject signal goes to low level, and the image memory 30 does not accept writing. Pixel data to be written to the memory units #7 and #15 remains temporarily held in the pixel data storage 20. Pixel data is read from the memory units #7, #0, #15 and #8. The memory units for writing and memory units for reading in the clock period C8 are as shown in FIG. 12D.

During the clock period C9, the write memory selection signal indicates #7 and #15. On the other hand, the memory for reading is memory units #0, #1, #8 and #9, so that in the clock period C9, contention for memory units #7 and #15 has ended. At this time, pixel data from the pixel data storage 20 is stored in the memory units #7 and #15. Pixel data to be stored in the memory units #0 and #8 is held in the pixel data storage 20. Pixel data is read from the memory units #0, #1, #8 and #9. The memory units for writing and memory units for reading in the clock period C9 are as shown in FIG. 12E.

During the clock period C10, the write memory selection signal indicates #0 and #8. On the other hand, the memory for reading is memory units #1, #2, #9 and #10, so that contention between writing and reading does not occur, and therefore writing and reading can be executed simultaneously. The situation is similar for the clock period C11 and beyond. The memory units for writing and memory units for reading in the clock period C10 are as shown in FIG. 13A, and the memory units for writing and memory units for reading in the clock period C11 are as shown in FIG. 13B.

Writing of pixel data to the image memory 30 is executed along horizontal lines of the input image to the memory units #0, #1, . . . , #7, #0, #1, . . . , but reading of pixel data from the image memory 30 is not necessarily executed in this order. This is because the memory from which pixel data is to be read is decided by the read memory selection circuit 43 based on the vertical and horizontal coordinate integer parts Yi_i and Xi_i. For example, there are cases in which pixel data is read from the memory units #2, #3, #10 and #11 in the clock period C11, and pixel data is also read from the memory units #2, #3, #10, #11 in the immediately following clock period C12. The memory units for writing and memory units for reading in the clock period C11 are as shown in FIG. 13B, and the memory units for writing and memory units for reading in the clock period C12 are as shown in FIG. 13C. In this case also, pixel data for four adjacent pixels can be read simultaneously without problem.

There are cases in which pixel data is read from the memory units #3, #4, #11 and #12 in the clock period C13, and pixel data is also read from the memory units #12, #13, #4 and #5 in the immediately following clock period C14. This is because there are cases in which, as a result of coordinate calculations by the read memory selection circuit 43, the coordinates of the four adjacent pixels for reading are shifted by one line in the vertical direction from the coordinates of the immediately preceding four adjacent pixels. The memory units for writing and memory units for reading in the clock period C13 are as shown in FIG. 13D, and the memory units for writing and memory units for reading in the clock period C14 are as shown in FIG. 13E. In this case also, pixel data for four adjacent pixels can be read simultaneously without problem.

Even when single-port memory is used as the memory for holding pixel data, the image interpolation device of this embodiment can execute writing and reading in parallel, so that image correction can be executed normally. Further, writing and reading can be executed in synchronization with the pixel clock, so that there is no need to raise the clock frequency for writing and reading, and power consumption can be suppressed. In addition, the memory is divided into a plurality of memory units, so that the operating ratio for each memory is decreased and power consumption can be reduced. Because there is no need to use dual-port memory, the transistor gate scale can be reduced, and as a result, chips can be manufactured at low cost. In this way, the image correction device of this embodiment can perform normal image interpolation at low cost and with low power consumption.

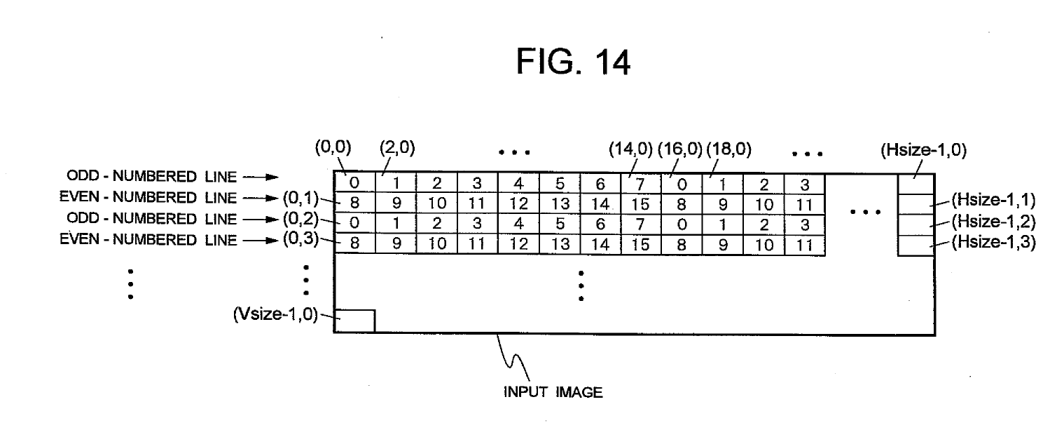

This embodiment assumes pixel data in a YUV 4:4:4 format, or in an RGB or monochrome (black-and-white) format, but can also be applied to a YUV 4:2:2 format, in which the resolution of the chrominance UV is one-half that of the luminance Y. In the case of a YUV 4:2:2 format, similar to this embodiment, the pixel data for luminance Y is stored such that pixel data numbers shown in FIG. 2 correspond to memory numbers shown in FIG. 3. On the other hand, for the chrominance UV, pixel data is stored such that pixel data numbers shown in FIG. 14 correspond to memory numbers shown in FIG. 3. In FIG. 14, one pixel data value is associated with two coordinates in the horizontal direction. This is because the resolution for chrominance UV is half the resolution for luminance Y.

This embodiment is an example in which the image memory is divided into eight portions in the horizontal direction and into two portions in the vertical direction. This is an example of appropriate division when the rotation angle of the input image is for example approximately 5° with respect to the horizontal direction, but division of the image memory is not limited to this configuration. For example, the horizontal direction may be divided into two portions, and the vertical direction divided into eight portions in order cope with a case where the input image rotation angle is close to 90°. Alternatively, the horizontal direction may be divided by 2×n (where n is an integer equal to or greater than 2) and the vertical direction may be divided into 2×m (where m is an integer equal to or greater than 2) in order to cope with various rotation angles. Division of the image memory into even numbers of portions in this way is convenient for performing various calculations in binary.

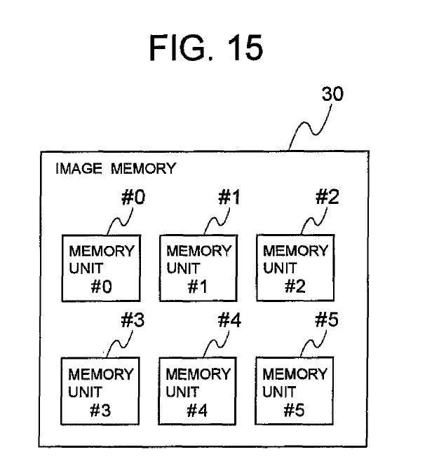

When a bilinear method is used to perform image interpolation, and four adjacent pixels are read simultaneously, the image memory must have at least six single-port memory units in order to ensure that there is no contention between writing and reading. This is because four memory units for simultaneous reading of four adjacent pixels, and two memory units for writing two pixel data values (i.e., six units in total) are sufficient. In this case, for example three memory units may be provided for odd-numbered lines and another three memory units may be provided for even-numbered lines, as shown in FIG. 15. In this drawing, the image memory 30 has memory units #0 to #2 for odd-numbered lines and memory units #3 to #5 for even-numbered lines.

In this embodiment, each of the memory units #0 to #15 can store the pixel data for 64 horizontal lines. This also is an example of division appropriate for a case in which the input image rotation angle is for example approximately 5° with respect to the horizontal direction; but the number of horizontal lines of pixel data which can be stored is not limited to this number. For example, if the rotation angle is smaller than 5°, the number of horizontal lines storable in each memory unit may be smaller than 64. Also, if the rotation angle is larger than 5°, the number of horizontal lines storable in each memory unit may be greater than 64.

In this embodiment, the number of pixel data values which can be stored by the pixel data storage 20 is eight. This also is an example of division appropriate for a case in which the input image rotation angle is for example approximately 5° with respect to the horizontal direction; but the number of pixel data values which can be stored is not limited to this number. For example, if the rotation angle is smaller than 5°, the speed of movement in the horizontal direction in pixel data reading is comparatively fast, and the time from the occurrence of contention between writing and reading until the end of contention is short, so that the number of pixel data values which can be stored by the pixel data storage 20 may be smaller than eight.

In this embodiment, four pixel data values are read simultaneously in order to accommodate image interpolation using a bilinear method; but five or more pixel data values may be read simultaneously in order to accommodate other image interpolation.

This embodiment is an example of a case in which angle correction (rotation) of an input image is performed, but can also be applied when left/right inversion of an input image is carried out. This processing can easily be realized by reversing the order of writing the pixel data to the memory units #0 to #15. Alternatively, processing can easily be realized by reversing the order of reading pixel data. This processing can also be applied to either moving images or to still images.

An image interpolation device can for example be applied to a rearview monitor for automobiles. In this application, an input image is obtained by a video camera that captures an image in rear of the automobile. Then, rotation within for example a range of approximately 5° is applied to the input image. Based on the interpolated image data obtained by this rotation, an output image is displayed on a display screen within the vehicle. Thus, even when for example the video camera for rear image capture is tilted with respect to the road surface, an output image parallel with the road surface can be displayed on the display screen. If reading is given priority when there is contention between writing and reading, as in the illustrated embodiment, halting of output, and stopping of the video image on the monitor or partial skipping of display images, can be prevented. Therefore, the output image is present on the display screen in realtime. It should be noted that use of an image interpolation device of this invention is not limited to the automobile, and many other applications are possible without departing from the spirit and scope of the present invention.

This application is based on Japanese Patent Application No. 2008-244014 filed on Sep. 24, 2008 and the entire disclosure thereof is incorporated herein by reference.

What is claimed is:

1. An image interpolation device comprising:
an image memory which stores input image data;
a memory write controller which controls writing of said input image data to said image memory;
a memory read controller which controls reading of said input image data from said image memory;
an interpolation unit which performs image interpolation on said input image data read from said image memory and obtains interpolated image data; and
a pixel data storage which temporarily and sequentially holds, as a unit pixel data group, a predetermined volume of data for mutually adjacent pixels in the vertical direction of said input image data,
wherein said image memory can store at least three of said unit pixel data groups,
wherein said memory write controller sequentially writes said unit pixel data group from said pixel data storage to said image memory, and
wherein said memory read controller simultaneously reads at least two groups among said unit pixel data groups stored in said image memory.

2. The image interpolation device according to claim 1, wherein said pixel data storage temporarily and sequentially holds, as said unit pixel data group, one pixel data in an odd-numbered line of said input image data and one pixel data in an even-numbered line adjacent to said one pixel data,
wherein said image memory includes at least three single-port memory units for odd-numbered lines, which store pixel data for odd-numbered lines of said input image data, and at least three single-port memory units for even-numbered lines, which store pixel data for even-numbered lines of said input image data,
wherein said memory write controller sequentially writes pixel data for the odd-numbered lines of said unit pixel data groups held in said pixel data storage to said single-port memory units for odd-numbered lines, and sequentially writes pixel data for the even-numbered lines of said unit pixel data groups to said single-port memory units for even-numbered lines, and
wherein said memory read controller simultaneously reads pixel data stored in each of at least two continuous memory units among said single-port memory units for odd-numbered lines, and pixel data stored in each of at least two continuous memory units among said single-port memory units for even-numbered lines.

3. The image interpolation device according to claim 2, wherein the number of said single-port memory units for odd-numbered lines is 2×n (where n is an integer equal to or greater than 2) and the number of said single-port memory units for even-numbered lines is 2×m (where m is an integer equal to or greater than 2).

4. The image interpolation device according to claim 2, wherein said memory write controller starts writing of pixel data held in said pixel data storage from a first one of said single-port memory units for odd-numbered lines, and when finishing writing to the last single-port memory unit for odd-numbered lines, said memory write controller again, starts writing of pixel data from said first single-port memory unit for odd-numbered lines, and wherein said memory write controller starts writing of pixel data held in said pixel data storage from a first one of said single-port memory units for even-numbered lines, and when finishing writing to the last single-port memory unit for even-numbered lines, said memory write controller starts again writing of pixel data from said first single-port memory unit for even-numbered lines.

5. The image interpolation device according to claim 1, wherein said image memory provides said pixel data storage with a write accept/rejection signal indicating that there is contention between writing and reading, when it is determined that a memory unit for reading decided by said memory read controller and a memory unit for writing decided by said memory write controller are the same, and
wherein said pixel data storage does not supply pixel data held by said pixel data storage to said image memory when said pixel data storage receives the write accept/reject signal indicating that there is contention.

6. The image interpolation device according to claim 1, wherein the speed at which said pixel data storage sequentially holds said unit pixel data groups is slower than the speed at which said memory write controller writes said unit pixel data groups to said image memory.

7. The image interpolation device according to claim 1, wherein writing by said memory write controller and reading by said memory read controller are executed in synchronization with a pixel clock, and holding by said pixel data storage is executed in synchronization with a timing which lags the timing of said pixel clock.

8. The image interpolation device according to claim 1, wherein said pixel data storage is an FIFO memory.

9. An image interpolation device comprising:
an image memory which stores input image data;
a memory write controller which controls writing of said input image data to said image memory;
a memory read controller which controls reading of said input image data from said image memory;
an interpolation unit which performs image interpolation on input image data read from said image memory and obtains interpolated image data; and
a pixel data storage which temporarily and sequentially holds continuous pixel data along odd-numbered lines among horizontal lines of said input image data and pixel data of even-numbered lines adjacent to said pixel data,
wherein said pixel data storage temporarily and sequentially holds, as a unit pixel data group, one pixel data in an odd-numbered line of said input image data and one pixel data in an even-numbered line adjacent to said one pixel data,
wherein said image memory includes at least three single-port memory units for odd-numbered lines, which store pixel data for odd-numbered lines of said input image data, and at least three single-port memory units for even-numbered lines, which store pixel data for even-numbered lines of said input image data,
wherein said memory write controller sequentially writes pixel data for the odd-numbered lines of said unit pixel data groups held in said pixel data storage to said single-port memory units for odd-numbered lines, and sequentially writes pixel data for the even-numbered lines of said unit pixel data groups to said single-port memory units for even-numbered lines, and
wherein said memory read controller simultaneously reads pixel data stored in each of at least two continuous memory units among said single-port memory units for odd-numbered lines, and pixel data stored in each of at least two continuous memory units among said single-port memory units for even-numbered lines.
